(19) United States
(12) Patent Application Publication
(10) Pub. No.: US 2006/0193233 A1
(43) Pub. Date: Aug. 31, 2006

(54) Light control apparatus and drive method therefor

(76) Inventors: Yoshikazu Fujimori, Ukyo-Ku (JP); Ken Nakahara, Ukyo-Ku (JP); Takashi Nakamura, Ukyo-Ku (JP)

Correspondence Address: CANTOR COLBURN, LLP, 55 GRIFFIN ROAD SOUTH, BLOOMFIELD, CT, 06002, US

(21) Appl. No.: 11/371,669

(22) Filed: Mar. 9, 2006

Related U.S. Application Data
(63) Continuation of application No. PCT/JP04/12517, filed on Aug. 31, 2004.

(30) Foreign Application Priority Data
Sep. 10, 2003 (JP) JP2003-319108

(51) Int. Cl. G11B 7/00

(52) U.S. Cl. 369/103

(57) ABSTRACT

A light control apparatus including a plurality of two-dimensionally arranged pixels, each of the plurality of pixels comprising a first storage element which stores a luminance value of a present frame for the pixel; a second storage element which stores a preliminary luminance value for the pixel; and a switching element which changes the luminance value for the pixel by transferring the luminance value stored in the second storage element to the first storage element.

### CROSS-REFERENCE TO RELATED APPLICATION

The present application is a continuation of PCT/JP2004/012517, filed on Aug. 31, 2004, the entire contents of which are incorporated herein by reference, and which claims the benefit of the date of the earlier filed Japanese Patent Application No. JP 2003-319108 filed on Sep. 10, 2003.

### BACKGROUND OF THE INVENTION

1. Field of the Invention

The present invention relates to a light control apparatus and a drive method therefor.

2. Description of the Related Art

The digital information system utilizing the principle of holography has been known recently as a large-capacity recording scheme (See Reference (1) in the following Related Art List, for instance).

FIG. 13 illustrates an example of hologram recording apparatuses. The hologram recording apparatus 100 mainly includes a laser light source 102, a beam splitter 104, a beam expander 106, a spatial light modulator SLM 108, a holographic pattern writing means 110, a Fourier transform lens 112, a recording medium 114, a mirror 116 and a rotating mirror 118. A transmission-type display apparatus is used here as the spatial light modulator SLM 108.

In the hologram recording apparatus 100, laser light emitted from the laser light source 102, is split into two beams by the beam splitter 104. In one of the beams, the diameter of the beam is expanded by the beam expander 106, and the spatial light modulator SLM 108 is irradiated with this beam that serves as parallel light. The holographic pattern writing means 110 sends holographic patterns to the spatial light modulator SLM 108 in the form of electric signals. Based on the electric signal received, the spatial light modulator SLM 108 forms a holographic pattern on the plane surface. When the light with which the spatial light modulator SLM 108 is irradiated permeates through the spatial light modulator SLM 108, it undergoes the optical modulation and becomes signal light containing holographic patterns. This signal light passes through the Fourier transform lens 112 where it is subjected to the Fourier transform, and is then focused into the recording medium 114. On the other hand, the other of the beams split by the beam splitter 104 is introduced via the mirror 116 and the rotating mirror 118 into the recording medium 114 as reference light. The optical path of the signal light and that of the reference light containing the holographic pattern intersect with each other in the recording medium 114 to form an optical interference pattern. The entire optical interference patterns are recorded on the recording medium 114 in the form of changes in refractive index (refractive-index lattice).

The hologram recording apparatus 100 records a first frame of image on the recording medium 114 in this manner. When recording the first frame of image has been completed, the rotating mirror 118 is rotated by a predetermined amount and moved in parallel by a predetermined amount. The angle of incidence of the reference light against the recording medium 114 is changed so as to record a second frame of image by using the same procedure. Repeating such processing as above achieves the angular multiplexing recording.

With a conventional active matrix type display unit, the pixels disposed in a matrix have a plurality of thin-film transistors (TFTs) formed at each of the intersections of scanning lines and signal lines, which are used as switching elements to selectively drive the corresponding pixels. As the pixels on a display unit so structured are selected sequentially, luminance data for the pixels are written line by line until the data are written sequentially to all the pixels constituting, the display screen. As soon as the brightness data of a frame are written to all the pixels constituting the display screen, the writing of brightness data of a new frame is started and carried out in the same manner.

FIGS. 14A, 14B and 14C are schematic diagrams showing how luminance data are written on a display unit as described above. As shown in FIG. 14A, the pixels on a conventional display unit keep emitting light according to the luminance data of a previous frame until luminance data of the next frame are written thereto. This results in a condition where a lower part of the screen as shown displays the luminance data of a previous frame while an upper part thereof displays the luminance data of a current frame.

FIG. 14B illustrates the time periods for writing luminance data of two consecutive frames. As is shown in FIG. 14B, the time when the luminance data of the same frame are displayed simultaneously is a very short time between the end of writing luminance data of a frame to all the pixels and the start of writing luminance data of the next frame. In the display of a conventional display unit, therefore, there is always a mixed presence of luminance data of a plurality of frames during the period when data are being written to the pixels.

With a display unit intended for human eyes, however, this causes no problems of human observers complaining of any sense of unnaturalness about the display of brightness data of partially different frames while the brightness data is being rewritten line by line. It is because the luminance data are rewritten at a speed faster than human recognition, that is, at 60 frames of image data per second, for instance.

### RELATED ART LIST

(1) Japanese Patent Application Laid-Open No. 2002-297008.

However, when an active matrix type display unit is to be used as a spatial light modulator (SLM) of a hologram recording apparatus, the spatial light modulator must be displaying a holographic pattern of a single frame only while the holographic pattern is being recorded in the recording medium. Hence, after the writing of the luminance data of a frame to the display unit, the writing of luminance data of a next frame cannot be started until the recording of the holographic pattern to the recording medium is finished. As a result, it takes a long time to record a holographic pattern to a recording medium as illustrated in FIG. 14C.

### SUMMARY OF THE INVENTION

The present invention has been made in view of the foregoing circumstances and a general purpose thereof is to provide a technology for lengthening the time of simultaneous display of data of a single frame on the display screen. An advantage of the present invention is to provide a technology for efficiently carrying out the switching to the display of data of another frame while lengthening the time of simultaneous display of data of a single frame on the display screen.

One embodiment of the present invention relates to a light control apparatus which includes a plurality of two-dimensionally arranged pixels. Each of the plurality of pixels includes: a first storage element which stores the luminance value of a present frame for the pixel; a second storage element which stores a preliminary luminance value for the pixel; and a switching element which changes the luminance value for the pixel by transferring the luminance value stored in the second storage element to the first storage element.

The switching element may, for instance, be a MOS transistor. The first storage element and the second storage element may each be an SRAM, for instance.

Here, the preliminary luminance value may, for instance, be the luminance value of a next frame. Such an arrangement may make it possible to write the luminance values of a next frame to the respective second storage elements in the background while the light control apparatus has its pixels emit light according to their respective luminance values of a present frame. This allows a switch to the next display of pixels simply by driving the switch elements thereof, so that the time for writing luminance data to the pixels and the time for display will be shortened.

A light control apparatus according to the embodiment of the present invention may further include a control apparatus which simultaneously performs on/off of switching elements each provided for each of a plurality of pixels.

A light control apparatus according to the embodiment of the present invention may further include a control apparatus which writes luminance values to second storage elements while a plurality of pixels are emitting light according to the luminance values held in the respective first storage elements.

Another embodiment of the present invention relates to a driving method for a light control apparatus which includes a plurality of two-dimensionally arranged pixels. The driving method is such that luminance values of a next frame are written sequentially to a plurality of pixels in the background while all the plurality of pixels are emitting light according to their respective luminance values of a present frame.

The driving method for a light control apparatus according to the another embodiment of the present invention can switch the display such that all the plurality of pixels emit light according to their respective luminance values of a next frame after the luminance values of the next frame are written to all the plurality of pixels.

In a light control apparatus according to still another embodiment of the present invention a plurality of pixels thereof may be comprised of a light modulating film having an electro-optical effect and a plurality of electrode pairs which are two-dimensionally arranged on the light modulating film. A pair of electrodes may be provided in such a manner as to be disposed counter to each other in a plane substantially perpendicular to the thickness direction of the light modulating film. In this arrangement, the pair of electrodes may be formed in a comb shape each and arranged so that their teeth are interposed between the teeth of the other. In this case, an electric field will be applied in the direction substantially perpendicular to the thickness direction of the light modulating film.

In the light control apparatus according to the still another embodiment of the present invention, a plurality of pixels thereof may be comprised of a reflecting film provided between a light modulating film and a second storage element.

A reflecting film thus provided between a light modulating film and a second storage element makes it possible to take out the light modulated in the light modulating film through reflection by the reflecting film. This arrangement allows the use of the whole surface of the light modulating film as the display area. Also, the substrate may be made of a material which is opaque to the light irradiated to the light modulating film. In this arrangement, even when the substrate is made of a material, such as silicon, opaque to visible light, it is possible to irradiate visible light to the light modulating film and take out the light by modulating the phase of the light reflected by the reflecting film. Here, the reflecting film may be a metal film of Pt or the like, for instance.

Furthermore, it is also possible that the reflecting film is made of a conductive material and the reflecting film is used as one electrode of a pair of electrodes. In this case, an electric field will be applied in the thickness direction of the light modulating film.

A light control apparatus may further include a polarizing plate which is provided on a light modulating film. This arrangement makes it possible to take out visually the light, of which the phase has been modulated, by way of the polarizing plate.

With a metal film thus placed, a drive circuit for a switching element, a second storage element and the like may be provided on the back surface thereof (surface opposite to the surface where a light modulation film is provided). This arrangement allows the use of the whole surface of the light modulating film as the display area and the whole back surface of the metal film as the area for placing the drive circuit. Accordingly, even when an SRAM is used as a second storage element, it is possible to secure a wider display area of a light control apparatus.

In a light control apparatus according to the still another embodiment of the present invention the pairs of electrodes thereof may be so structured as to function as first storage elements Such an arrangement may simplify the structure of the light control apparatus.

In a light control apparatus according to the still another embodiment of the present invention, a light modulating film thereof may be structured by a material whose refractive index changes with the strength of electric field applied. In a light control apparatus according to the still another embodiment of the present invention, a light modulating film may be made of a solid material.

When the solid material is used as the light modulating film, its refractive index varies with a change in the state of electron distribution and thereby the response of when the electric field is applied is raised. This makes it possible to switch on/off the light at high speed. Moreover, the use of the solid material for the light modulating film can increase the durability as compared to the cases where a film of a liquid crystal state is used. Although examples of materials used for such a solid light modulating film include PLZT, LiNbO₃, GaAs-MQW, SBN((Sr,Ba)Nb₂O₆) and so forth, PLZT is preferably used as will be described later.

In a light control apparatus according to still another embodiment of the present invention, a light modulating film thereof may be structured by a material whose refractive index changes in proportion to the square of electric field applied. The use of a light modulating film made of a material that has a secondary electro-optical effect like this can realize a faster on/off of light.

In a light control apparatus according to still another embodiment of the present invention, the light modulating film may be made of PLZT that containing Pb, Zr, Ti and La as constituent elements.

A light modulating film according to still another embodiment of the present invention is characterized in that it is made of polycrystalline PLZT that contains Pb, Zr, Ti and La as constituent elements, the La content in the film is in a range of 5 to 30 atomic percentage (inclusive), and the dielectric constant thereof at a frequency of 1 MHz is greater than or equal to 1200.

A light modulating film according to still another embodiment of the present invention is characterized in that it is made of polycrystalline PLZT that contains Pb, Zr, Ti and La as constituent elements, the La content in the film is in a range of 5 to 30 atomic percentage (inclusive), and the average particle size of grains constituting the polycrystalline PLZT is 800 nm or greater.

A light modulating film according to still another embodiment of the present invention is characterized in that it is made of polycrystalline PLZT that contains Pb, Zr, Ti and La as constituent elements, and the La content in the film is in a range of 5 to 30 atomic percentage (inclusive). The light modulating film is further characterized in that the value of I(111)/I(110) is greater than or equal to 1, where the X-ray diffraction intensity on the (110) plane and that on the plane (111) of the polycrystalline PLZT are denoted by I(110) and I(111), respectively. In this embodiment, that the La content is in a range of 5 to 30 atomic percentage (inclusive) corresponds to that the ratio of the number of La atoms to the sum of the numbers of Zr and Ti atoms is in the range of 5 to 30% (inclusive).

PLZT is a ferroelectric substance, and its polarity change rate is proportional to the exponential function of the electric field. This makes it possible to switch on and off the light at higher speed. The amount of increase in the electric field necessary for switching on and off the light can also be made smaller. Since PLZT crystals have low anisotropy, differences in switching speed between individual crystal grains are small. This can reduce the fluctuations of speed at the time of switching.

In addition, since the polycrystalline PLZT according to the still another embodiment of the present invention, it exhibits a stable and large quadratic electro-optic effect and therefore provides a superior performance as a light modulating film.

FIG. 15 is a phase diagram showing a relationship between the composition and the film characteristic of polycrystalline PLZT. Here, the vertical axis represents the ratio of the number of La atoms to the sum of the numbers of Zr and Ti atoms As shown in FIG. 15, the much quadratic electro-optic effect occurs when the composition has relatively high La contents. Given this fact, the inventors of the present invention attempted to form PLZT films from materials of high lanthanum compositions by using a sol-gel method, but the resultant films showed relatively low dielectric constants and small values of Kerr constants.

Although the definite reason for the above is not exactly known, it may be ascribable to how lanthanum exists in the polycrystalline PLZT. That is, it is speculated that in the polycrystalline PLZT-formed by the above process, lanthanum segregates on the grain boundaries of the polycrystalline PLZT and is not absorbed into the grains. In other words, PZT and La oxides lie in the film separately from each other, which seems to be responsible for a drop in the dielectric constant. If PZT and La oxides segregate from each other to form individual domains, the dielectric constant of the film is expected to approach the areal average of the dielectric constants of the respective materials. Here, the lanthanum oxide film has a dielectric constant of the order of 30, a value much smaller than that of PZT (1000 or above). Accordingly, if such a form is taken, the dielectric constant of the film as a whole will be lowered greatly.

Consequently, the inventors of the present invention conducted further research to examine how to fabricate a film, made of a high lanthanum composition, which has a high dielectric constant. As a result, the inventors found out that films having high dielectric constants could be obtained under a condition set in a manufacturing process by a sol-gel method. More specifically, for example, in the process of cooling after the grain growth by a heat treatment, the increased cooling rate can restrict a drop in the dielectric constant accompanied by the lanthanum precipitation. By employing such a method as this, manufacturing a high dielectric constant film that exhibits stably a superior quadratic electro-optic effect can be realized.

The light modulating film described above contains a high lanthanum composition with a La content in the range of 5 to 30 atomic percentage (inclusive). And the polycrystalline PLZT has a large value of the dielectric constant of 1200 or above at a frequency of 1 MHz. As mentioned previously, the dielectric constant indicates whether the lanthanum is taken into grains or not. Such a high dielectric constant is achieved by a mode wherein a substantial amount of lanthanum is taken into the grains of the polycrystalline PLZT. This structure, as described above, can be fabricated by increasing the cooling rate in the process of cooling after the heat treatment for grain growth. This structure is suitably used as an element that exhibits stably a superior quadratic electro-optic effect.

The light modulating film is such that the average particle size of the grains constituting the polycrystalline PLZT is greater than or equal to 800 nm. Accordingly, the lanthanum is easily taken into the grains of the polycrystalline PLZT, whereby a high quadratic electro-optic effect is exerted stably. Moreover, the large particle sizes of the grains lower the density of the grain boundaries, thereby suppressing dispersion of incident light. As a result thereof, when this light modulating film is applied to a light control element that utilizes the quadratic electro-optic effect, highly efficient superior elements and devices are obtained.

A third structure is such that the value of I(111)/I(110) is greater than or equal to 1, where the X-ray diffraction intensity on the (110) plane of the polycrystalline PLZT and that on the plane (111) of the polycrystalline PLZT are denoted by I(110) and I(111), respectively. That is, in this structure, the crystal grains of the polycrystalline PLZT are oriented in the (111) direction preferentially.

When PLZT crystal grains are to be oriented in the (100) direction preferentially, light dispersion increases if there exists a (001)-oriented crystals besides a (100)-oriented crystal. In contrast thereto, the preferential orientation in the (111) direction can reduce deviations in the direction of crystal orientation. Thus this can suppress the light dispersion at the grain boundaries, thereby enhancing the electro-optic effect. It is to be noted that crystal structures dominant in the PLZT films according to the embodiments of the present invention are cubic and tetragonal. Accordingly, the quadratic electro-optic effect can be stably exhibited by optimizing the arrangement of these crystal grains in the film

According to this embodiment of the present invention, the peak half width of the X-ray diffraction on the (111) plane is made smaller than or equal to 5 degrees, so that the film crystallinity is enhanced. Accordingly, the electro-optic effect can be raised.

Furthermore, a method of fabricating a light modulating film according to the embodiments of the present invention includes applying a liquid containing Pb, Zr, Ti and La onto a surface of a substrate and drying it to form a film before heating the film for crystallization and cooling it at a rate greater than 1200° C./min.

This manufacturing method includes the rapid cooling after the heat treatment. Such cooling can suppress a drop in the dielectric constant involving the precipitation of lanthanum. As a result, a high dielectric constant film that stably exhibits a superior quadratic electro-optic effect can be produced. By employing such a method, a light modulating film having the above-described advantageous characteristics can be formed, for example, on a substrate made of silicon or the like.

It is to be noted that any arbitrary combination or rearrangement of the above-described structural components and so forth are all effective as and encompassed by the present embodiments.

Moreover, this summary of the invention does not necessarily describe all necessary features, so that the invention may also be sub-combination of these described features.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a circuit diagram showing a configuration of a light control apparatus according to an embodiment of the present invention;

FIG. 2A a schematic diagram showing how luminance data are written in a light control apparatus of ah embodiment of the present invention;

FIG. 2B a schematic diagram showing how luminance data are written in a light control apparatus of an embodiment of the present invention;

FIG. 3 illustrates another example of the circuit diagram shown in FIG. 1;

FIG. 4 is a partial cross-sectional view showing a structure of a light control apparatus according to an embodiment of the present invention;

FIG. 5 is a top view showing a form of a first electrode and a second electrode;

FIG. 6 illustrates a hologram recording apparatus.

FIG. 7A illustrates an arithmetic unit;

FIG. 7B shows a computational formula in which an output vector is determined by a logical operation of a plurality of pixel vectors (arithmetic matrix) with an input vector;

FIG. 8 is a partial cross-sectional view showing a structure of a transmission-type light control apparatus;

FIG. 9 shows a relationship between a refractive index and a Kerr constant of PLZT films according to the practical examples;

FIG. 10 shows a relationship between a dielectric constant and a Kerr constant of PLZT films according to the practical examples;

FIG. 11 shows a relationship between an X-ray diffraction peak strength and a Kerr constant of PLZT films according to the practical examples;

FIG. 12 shows a relationship between an X-ray diffraction peak half-width and a Kerr constant of PLZT films according to the practical examples;

FIG. 13 illustrates an example of hologram recording apparatuses;

FIG. 14A is a schematic diagrams showing how luminance data are written on a conventional display unit;

FIG. 14B is a schematic diagrams showing how luminance data are written on a conventional display unit;

FIG. 14C is a schematic diagrams showing how luminance data are written on a conventional display unit;

FIG. 15 is a diagram showing a phase state of PLZT; and

FIG. 16 illustrates another example of light control apparatus shown in FIG. 4.

### DETAILED DESCRIPTION OF THE INVENTION

The invention will now be described based on the following embodiments which do not intend to limit the scope of the present invention but exemplify the invention. All of the features and the combinations thereof described in the embodiments are not necessarily essential to the invention.

Light control apparatuses described in the following embodiments may be applied to spatial light modulators SLM in hologram recording/reproducing apparatuses, display apparatuses, optical communication switches, optical communication modulators, optical arithmetic units, encryption circuits and so forth.

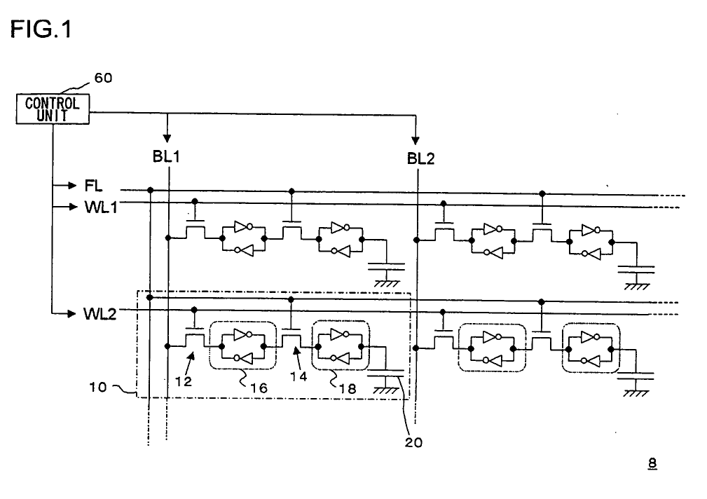

FIG. 1 is a circuit diagram showing the configuration of a light control apparatus 8 according to an embodiment of the present invention. The light control apparatus 8 includes a plurality of pixels 10 which are arranged two-dimensionally and a control unit 60 which writes luminance data to these pixels and performs other functions. Though not sown in FIG. 1, the light control apparatus 8 may also include a data control circuit which controls a plurality of bit lines BL, a selection control circuit which controls a plurality of bit lines BL, and so forth. In such a case, the control unit 60 controls these control circuits.

Pixels 10 each includes a first transistor 14, a first storage element 18, a second transistor 12, a second storage element 16 and an optical element 20. In the present embodiment, the first storage element 18 and the second storage element 16 are each an SRAM (Static Random Access Memory). The first storage element 18 stores the brightness data, or luminance data, of the optical element 20 for the current frame. The optical element 20 emits light according to the luminance data held by the first storage element 18. The second storage element 16 stores the luminance data of the optical element 20 for the next frame. The first transistor 14 functions as a switching element that changes the luminance value of the optical element 20 by transferring the luminance data held by the second storage element 16 to the first storage element 18. The use of SRAMs for the first storage element 18 and the second storage element 16 makes it possible to reduce any leftover in transferring the luminance data held by the second storage element 16 to the first storage element 18, thus realizing the transfer of the luminance data With higher accuracy.

In the second transistor 12, the drain (or source) thereof is connected to a bit line BL1, and the gate thereof is connected to a word line WL2. The source (or drain) thereof is connected to the second storage element 16. In the first transistor 14, the drain (or source) thereof is connected to the second storage element 16, and the gate thereof is connected to a switching line FL. The source (or drain) thereof is connected to the first storage element 18.

While optical devices 20 of all the pixels 10 that constitute a display screen are emitting light in accordance with the luminance data held in the corresponding first memory cells 18, the control unit 60 selects the word line WL1 and the bit line BL1, the word line WL1 and the bit line BL2, . . . in sequence and turns on the second transistors 12 of the pixels 10 in the first row and then writes luminance data on the next frame to the corresponding second storage element 16. When the writing of the luminance data to the second storage element 16 of the pixels 10 in the first row has completed, the control unit 60 selects the word line WL2 and the bit line BL1, the word line WL2 and the bit line BL2, . . . in sequence and turns on the second transistors 12 of the pixels 10 in the second row and then writes luminance data for the next frame to the corresponding second storage element 16. In this manner, while the luminance data for the present data are being displayed on all the pixels 10 of the light control apparatus 8, the control unit 60 writes, in the background, the luminance data for the next frame to each pixel 10.

When the luminance data for the next frame have been written to the second storage elements 16 of all the pixels. 10 of a light control apparatus 8, the control unit 60 applies a predetermined voltage to the switching line FL. As a result, the first transistors 14 of all the pixels 10 turn on nearly simultaneously, the luminance data for the next frame having been held by the second storage elements 16 are transferred to the corresponding first storage elements 18, and the optical elements 20 of all the pixels 10 emit light according to the corresponding luminance data for the next frame.

After this, the control unit 60 writes the luminance data for the subsequent frame to the second storage elements 16 of the pixels 10 by performing a similar processing.

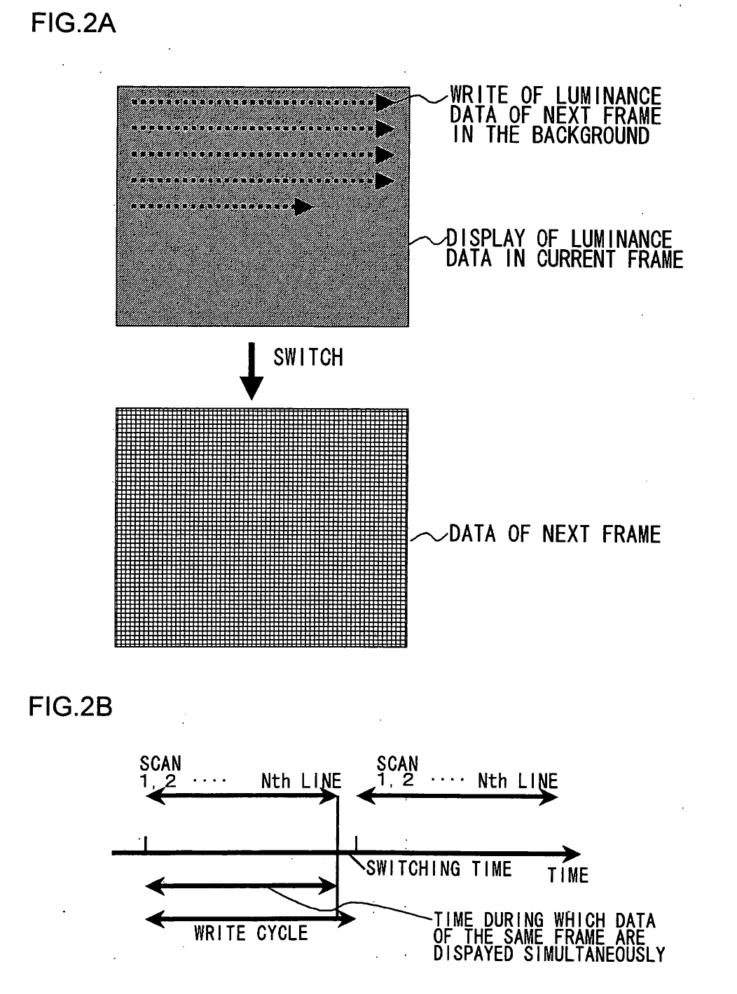

FIG. 2A and FIG. 2B are each a schematic diagram showing how luminance data are written in the light control apparatus 8 of the present embodiment. Referring to FIG. 2A, the display screen shows the luminance data for the current frame. Here, the luminance data for the next frame are being written, in the background, to the second storage elements 16 (see FIG. 1) of the respective pixels. During this time, the luminance data for the present frame are being displayed on all the pixels. When the writing of the luminance data in the background to the second storage elements 16 of all the pixels has completed, the control unit 60 applies a predetermined voltage to the switching line FL and the display screen is switched so that the luminance data for the next frame is displayed on the display screen. After this, the control unit 60 starts to write luminance data for the subsequent frame in the background again.

In this manner, as shown in FIG. 2B, the luminance data for the same frame are displayed on the display screen while luminance data are being written to the respective pixels.

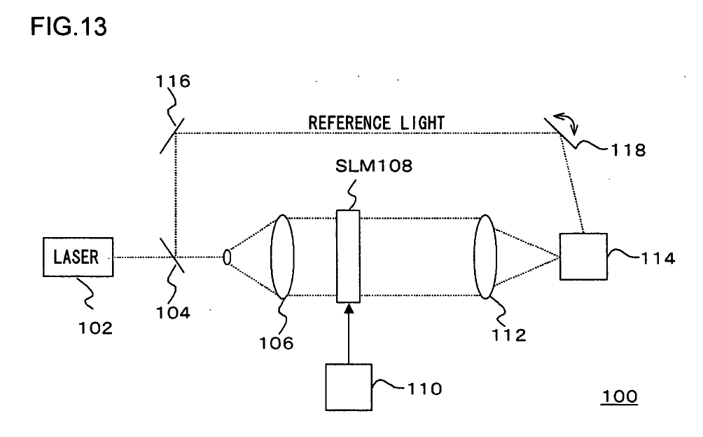

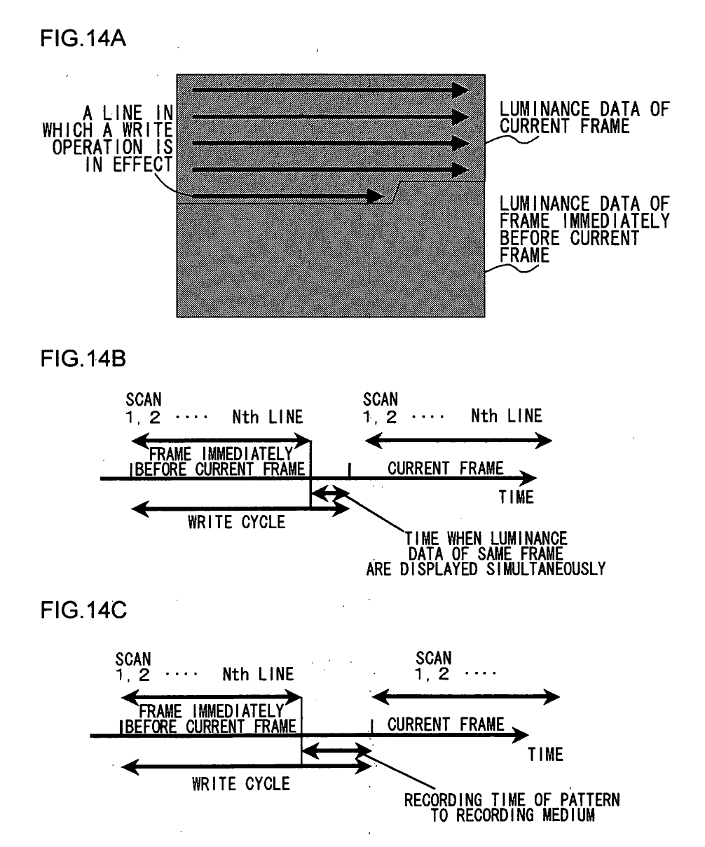

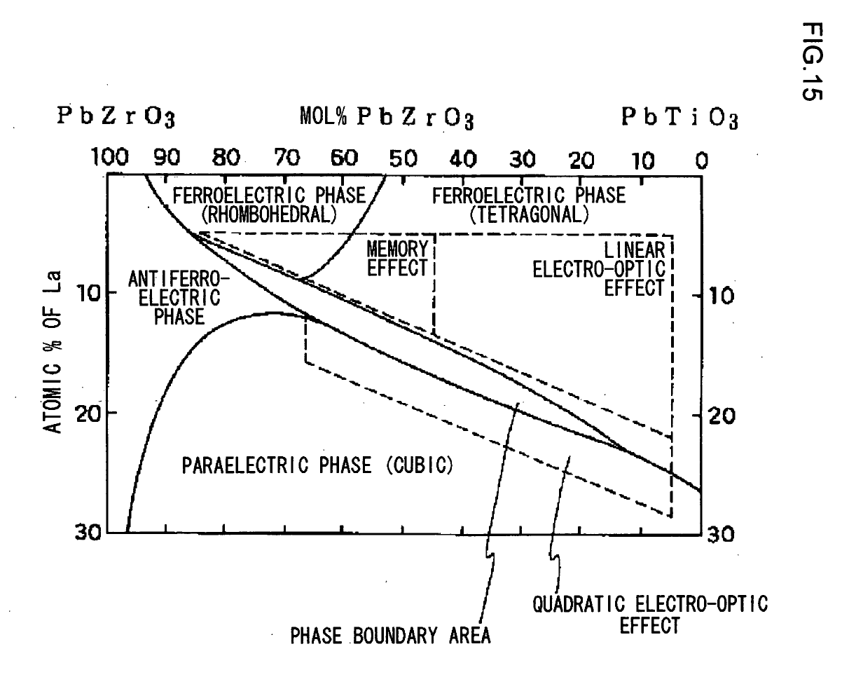

Hence, even when a light control apparatus 8 is used as a spatial light modulator SLM 108 of a hologram recording apparatus 100 as shown in FIG. 13, the luminance data for the current frame are displayed on the light control apparatus 8 while the luminance data for the next frame are being written to all the pixels in the background. As a, result, it is possible to write luminance data and record a holographic pattern in a recording medium 114 simultaneously, thus realizing an efficient recording of a holographic pattern in a recording medium 114. Also, the time for switching frames, which is only the physical time necessary for turning the first transistors 14 on by the application of a predetermined voltage to the switching lines FL by the control unit 60 (FIG. 1), can be very short, thus making the time for recording a holographic pattern in a recording medium 114 much shorter than that of a conventional system.

A transmission-type spatial light modulator SLM has so far been described, but the light control apparatus 8 may also be a reflection-type spatial light modulator SLM as will be described later. The use of a reflection type for the light control apparatus 8 enables the formation of a second storage element 16 and a first storage element 18 on the surface opposite to the holographic pattern, so that the display surface can be made wider even when a plurality of storage elements are provided for a pixel.

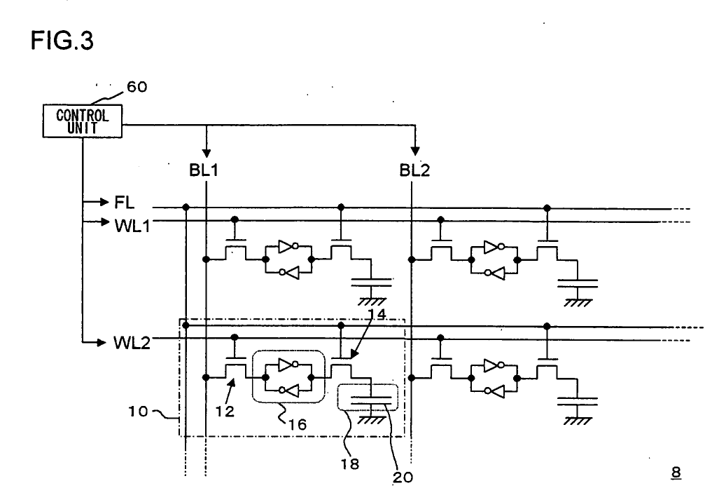

FIG. 3 illustrates another example of a circuit diagram as illustrated in FIG. 1. Here, the light control apparatus 8 does not have an SRAM as a first storage element 18 and an optical element 20 itself functions as a first storage element 18.

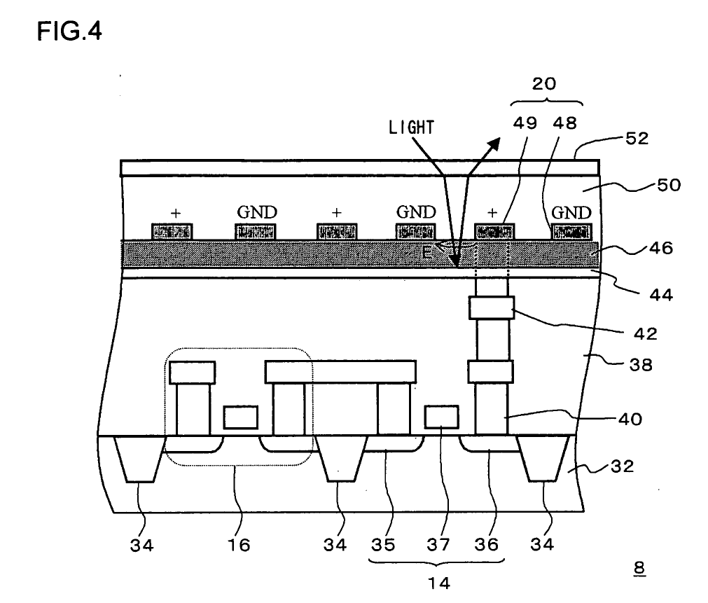

FIG. 4 is a partial cross-sectional view showing a structure of a light control apparatus 8 shown in FIG. 3. The light control apparatus 8 includes a substrate 32, an insulating film 38 formed on the substrate 32, a reflecting film 44 formed on the insulating film 38, a light modulating film 46 formed on the reflecting film 44, a first electrode 48 and a second electrode 49 arranged on the light modulating film 46, and a protection film 50 so formed as to cover the first electrodes 48 and second electrodes 49. A polarizing plate 52 is disposed on the protection film 50. While in this configuration the first electrode 48 and the second electrode 49 are arranged on the light modulating film 46, it is possible to form the first electrode 48 and second electrodes 49 on the reflecting film 44 and further form the light modulating film 46 thereon. The light modulating film 46 according to the present embodiment is made of a material whose refractive index varies in accordance with the intensity of an electric field applied thereto. As such the material, PLZT, LiNbO₃, GaAs-MQW, SBN((Sr, Ba)Nb₂O₆), and the like may be used. Amongst them, PLZT is used most preferably. Preferred forms of PLZT will be described later.

The substrate 32 is provided with element isolation regions 34, a drain (or source) 35, and a source (or drain) 36. The substrate 32 may be a single-crystal silicon substrate. A gate 37 is formed in the insulating film 38, and a first transistor 14 is constituted by the drain 35, the source 36 and gate 37. The insulating film 38 is made of a silicon oxide film, for example. A second transistor, which is an SRAM, is formed on the substrate 32 and the insulating film 38. The insulating film 38 is provided also with plugs 40 and wiring 42 which are formed in connection with the source 36. The wiring 42 is made of aluminum, for example. The plugs 40 are made of tungsten, for example.

The reflecting film 44 whose thickness is approximately 100 nm may be made of Pt, for example. The light modulating film 46 may be formed so that the film thickness thereof is approximately 1.2 μm, for example.

The first electrode 48 and the second electrode 49 (each having a thickness of approximately 150 nm) may be made of Pt, ITO (Indium Tin Oxide), IrO₂ or the like, for example. According to the present embodiment, the optical element 20 is constituted by a light modulating film 46, a first electrode 48 and a second electrode 49. When the first electrode and the second electrode 49 are formed on the light modulating film 46, it is preferable that these first electrode 48 and second electrodes 49 be made of a transparent material such as ITO. When IrO₂ is used for the first electrode 48 and the second electrode 49, the first electrode 48 and second electrodes 49 can also be used as transparent films if they are given a small thickness (for example, approximately 50 nm or so). This makes it possible to widen the display area of each pixel. The protection film 50 whose thickness is approximately several micrometers may be made of SiN or alumina, for example.

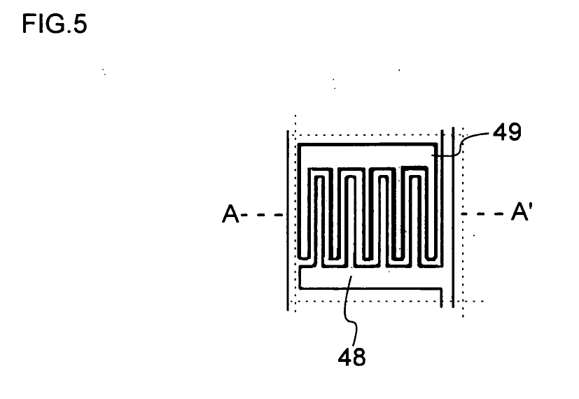

FIG. 5 is a top view showing a form of the first electrode 48 and the second electrode 49. The first electrode 48 and the second electrode 49 are each formed in a comb shape, and arranged so that their teeth are interposed between the teeth of the other. In the present embodiment, each pixel is composed of a pair of comb-shaped first electrode 48 and second electrodes 49. Here, the first electrode 48 and the second electrode 49 may be spaced apart by 0.5 to 1.5 μm, fox example. The width of the teeth of the first electrode 48 and second electrodes may be 0.5 to 1.5 μm, for example. When the spacing between the first electrode 48 and second electrodes 49 is set in this range, the refractive index of the light modulating film 46 can be controlled with high accuracy even if the difference in potential between the first electrode and the second electrode 49 is made smaller. FIG. 1 corresponds to the cross section taken along the line A-A′ of FIG. 5.

Referring back to FIG. 4, the first electrode 48 is grounded whereas the luminance data are applied to the second electrode 49. In the area constituting one pixel of the light modulating film 46, the refractive index of the light modulating film 46 varies in accordance with the voltage applied to the second electrode 49. In this state, when the light control apparatus 8 is irradiated with light from above the polarizing plate 52 thereof, the irradiating light passes through the polarizing plate 52 and enters the light modulating film 46 through the protection film 50. At this time, the light which has entered the light modulating film 46 is refracted with different angles according to the refractive index of the light modulating film 46 in that area. The light incident on the light modulating film 46 is reflected by the reflecting film 44, and then passes through the light modulating film 46 and the protection film 50, and exits from the polarizing plate 52. Then, the transmittance of the light that exits from the polarizing plate 52 varies depending on the refractive index of the light modulating film 46. This is how the luminance data of each frame can be displayed on the polarizing plate 52.

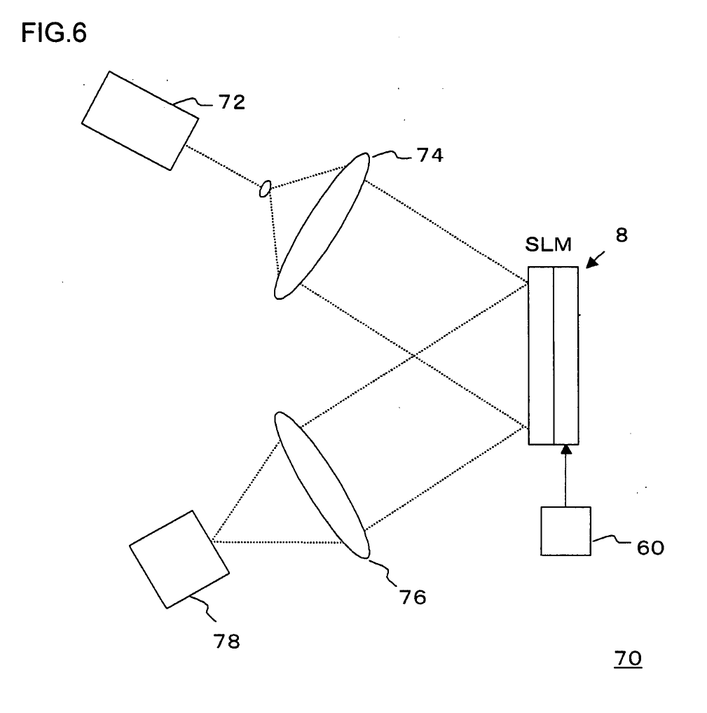

FIG. 6 is a diagram showing a hologram recording apparatus in which a reflection-type light control apparatus 8 as shown in FIG. 4 is used as a spatial light modulator SLM. A hologram recording apparatus 70 includes a laser light source 72, a beam expander 74, a Fourier transform lens 76, and a recording medium 78. A control unit 60 controls the formation of holographic patterns by the spatial light modulator SLM.

In the hologram recording apparatus 70, laser light emitted from the laser light source 72 is split into two beams by a beam splitter, not shown. One of the beams is used as reference light in the same way as in the hologram recording apparatus 100 shown in FIG. 13, and is introduced into the recording medium 78. The diameter of the other beam is expanded by the beam expander 74, and is irradiated to the spatial light modulator SLM (light control apparatus 8) as parallel light. At this time, a holographic pattern is being formed in the light control apparatus 8, in accordance with the differences in potential between the first electrode 48 and second electrodes 49 of each pixel. And the light with which the spatial light modulator SLM is irradiated is reflected from the spatial light modulator SLM as signal light containing the holographic pattern. This signal light passes through the Fourier transform lens 76 where it is subjected to the Fourier transform, and is then focused into the recording medium 78. The optical path of the signal light and that of the reference light containing the holographic pattern intersect with each other in the recording medium 114 to form an optical interference pattern. The entire optical interference patterns are recorded on the recording medium 78 in the form of changes in refractive index (refractive-index lattice).

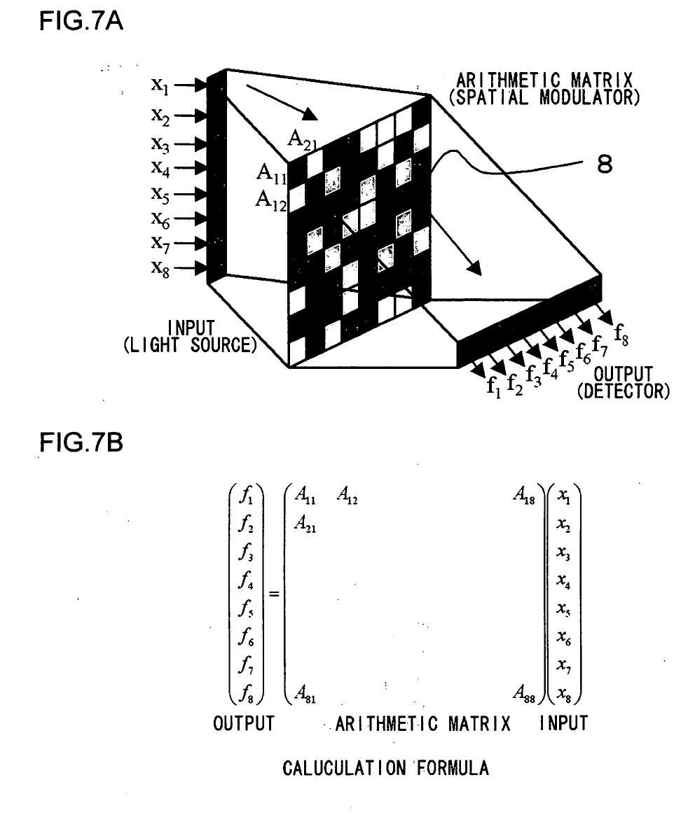

FIGS. 7A and 7B are diagrams showing an example where the light control apparatus 8 according to the present embodiment is applied to an optical arithmetic unit. As shown in FIG. 7A, a matrix of pixel vectors are displayed on the display screen of a light control apparatus 8. When the light from a light source is irradiated, as an input vector, to the light control apparatus 8, the logical operations between the input vector and the plurality of pixel vectors can be done in parallel and the result thereof is detected by a detector as an output vector. Thereby, as shown in FIG. 7B, the logical operations between the input vector (inputs x₁ to x₈) and a plurality of pixel vectors (arithmetic matrix or operation matrix) can be performed in parallel so as to determine the output vector (outputs f₁ to f₈). In this manner, since one-time operation determines the output vector by using the light control apparatus 8, the high-speed operation can be achieved. Though a description has been given of a transmission type as the light control apparatus 8, a reflection-type light control apparatus 8 may be used for the optical arithmetic unit.

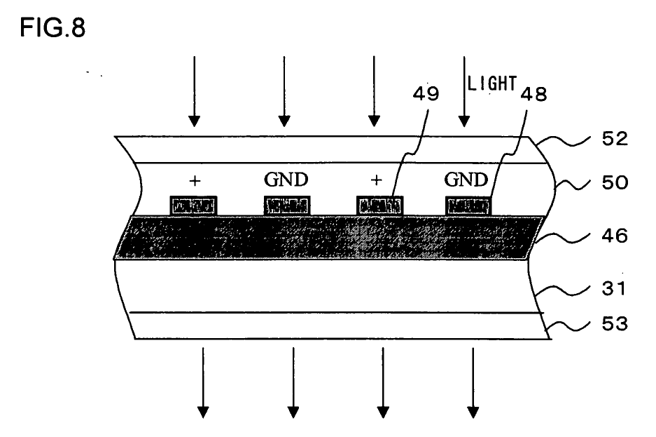

FIG. 8 illustrates a partial cross-sectional view of a transmission-type light control apparatus 8. When a transmission type is used as a light control apparatus 8, it is preferable that a glass or other transparent substrate 31 be used and ITO or other transparent electrodes be used as first electrodes 48 and second electrodes 49. In addition to a polarizing plate 52, a polarizing plate 53 is provided on the surface of the substrate 31 opposite to the surface on which a light modulating film 46 is provided. As a result of this arrangement, the light incident from the polarizing plate 52 side is modulated as it passes through the light modulating film 46, the light is turned on or off as it passes through the polarizing plate 53, and a signal light including a desired pattern is obtained according to a voltage applied to the light modulating film 46.

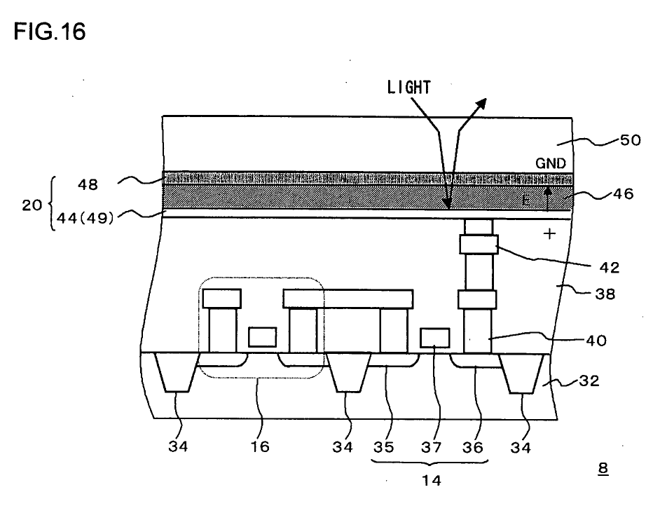

A light control apparatus 8 according to the present embodiment may also be structured as shown in FIG. 16. This structure differs from the one shown in FIG. 4 in that a reflecting film 44 is made of a conductive material and used as a second electrode 49. Here, the reflecting film 44 is formed separately for each pixel. The first electrode 48 may be a transparent electrode of ITO, IrO₂ or the like and may be formed all over the surface of the light modulating film 46. Here, an electric field is applied in the film thickness direction of the light modulating film 46. Although not shown in FIG. 16, the light control apparatus 8 may be so structured as to include a polarizing plate 52 similarly to the structure shown in FIG. 4. This makes it possible to take out the modulation of the phase of light visibly. Note also that the light control apparatus 8 as shown in FIG. 4 may be of a structure that does not include a polarizing plate 52.

Now, description will be given of preferred materials of the light modulating film 46 according to the embodiments of the present invention. It is preferably that the light modulating film 46 according to the embodiments have the following capabilities:
(1) None of the luminance data for the previous frame remains when the luminance data to be displayed on the display screen is switched by the control unit 60; and
(2) Fluctuations in the switching speed are small when the luminance data to be displayed on the display screen is switched by the control unit 60.

For materials that satisfy the above-described capabilities, it is preferable that PLZT films described below be used.

In the following embodiment, La composition means the ratio of the number of La atoms to the sum of the numbers of Zr and Ti atoms, unless otherwise specified.

First PLZT Film

As a first PLZT film, there is one formed by a sol-gel method on a reflecting film (Pt film) which is formed on a silicon substrate. The fabrication method will be described below.

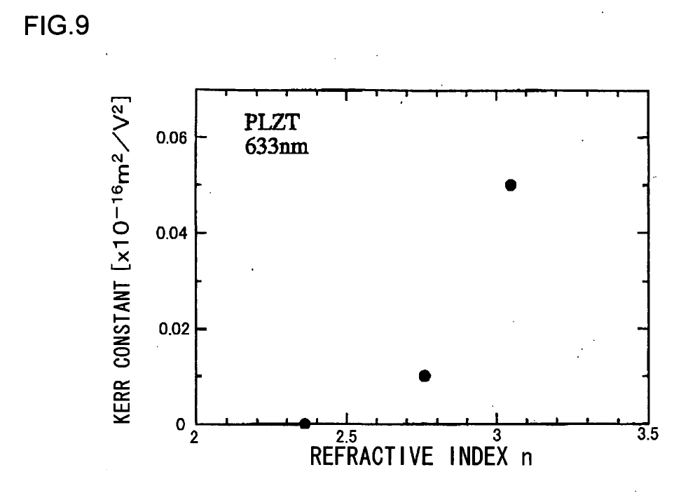

Initially, a silicon oxide film is formed on the silicon substrate, and the Pt film is formed thereon. A mixed solution containing-metal alkoxides of Pb, La, Zr, and Ti is spin-coated on the surface of the Pt film. Examples of the starting materials, or metal alkoxides, include Pb(CH₂COO)₂.3H₂O, La(O-i-C₃H₇)₃, Zr(O-t-C₄H₉)₄, and Ti(O-i-C₃H₇)₄. The atomic composition in the mixed solution shall be one from which the quadratic electro-optic effect is obtained in the phase diagram of FIG. 9. In the present embodiment, Pb:La:Zr:Ti=105:9:65:35. The thickness of the mixed solution is about 100 nm to 5 μm, for example,

After the spin-coating, drying is performed at predetermined temperatures, followed by pre-firing in a dry air atmosphere. For example, the drying temperature is between 100° C. and 250° C. (inclusive). Assume here that the temperature of 200° C. is employed. The pre-firing can be performed at or above 300° C., and preferably at or above 400° C. This can remove organic matters, moisture, and residual carbon with reliability. The duration of the pre-firing is 1 minute to 1 hour or so, for example. Before the pre-firing, the application and drying of the solution may be repeated until the predetermined thickness is reached.

Thereafter, a heat treatment is carried out in an O₂ atmosphere so that PLZT is crystallized for grain growth. For example, the heat treatment temperature is between 600° C. and 750° C. (inclusive). This range of temperatures can guarantee to crystallize PLZT. The heat treatment temperature is preferably at or above 700° C. This can increase the average particle size of the crystals. Accordingly, the specific surface areas of the grains can be reduced so as to suppress La precipitation. The duration of the heat treatment may be between 10 seconds and 5 minutes (inclusive), for example, and preferably 1 minute or longer. This can make the grains even greater.

After the heat treatment has been completed, the crystallized PLZT film is cooled rapidly. This cooling process is typically conducted at a rate of around 400° C./min to 1000° C./min. This makes it difficult, however, to introduce lanthanum into the PLZT grains in high concentrations. More specifically, if the material composition reaches or exceeds 7% in the percentage of the number of La atoms with respect to the sum of the numbers of Zr and Ti atoms, it becomes extremely difficult to introduce the same concentration of lanthanum into the grains as in the material composition. Thus, in the present embodiment, a higher cooling rate is employed in the process of cooling after the heat treatment. The cooling rate may be higher than 1200° C./min, and it may be set to 1800° C./min, for example.

Through the foregoing steps, a structure having the PLZT thin film formed on the silicon substrate is obtained. This PLZT thin film has a high La composition with a La content in the range of 5 at % and 30 at %. The PLZT obtained by the foregoing steps was measured for relative dielectric constant at a frequency of 1 MHz, and found to be 1200. From this value, it is considered that a sufficient amount of La is taken into the grains of the PLZT obtained in the present embodiment.

Second PLZT Film

A second PLZT film is fabricated by forming a seed layer on the Pt film formed on the silicon substrate and then spin-coating a metal alkoxide layer thereon. The formation of the seed layer makes it possible to obtain a uniform PLZT film having a satisfactory crystallinity. Also, a PLZT film having larger grain sizes can be obtained stably.

Assume here that a mixed solution for forming the seed layer is a liquid that contains seed particles, a surface-active agent of around 0.1% to 10% by weight and an organic solvent. This mixed solution is applied onto the silicon substrate by spin coating or the like, so as to form the seed layer. Since the formation of such a seed layer promotes favorable crystallization with the seed particles as cores, it becomes possible to obtain a uniform PLZT film having satisfactory crystallinity.

For example, Ti ultra-fine particles may be used as the seed particles. It is desirable that the Ti microfine powder have particle sizes of around 0.5 nm to 200 nm, and most preferably 1 nm to 50 nm or so. In order for ultra-fine particles or powder to make a core, a certain number of atoms are required. The core cannot be made out of a single atom only, and it is desirable that the size thereof be sufficiently larger than that of the atom or atoms of about 0.1 nm or so. If the core is too large, on the other hand, the centers of the Ti cores will remain intact. This in turn requires high annealing temperatures so as not to leave Ti. Also, the size exceeding 200 nm makes it difficult to form a flat and uniform PLZT film. When the size of core becomes larger, it is harder for the core to disperse into the solvent.

It is desirable that the concentration of seed particles be around 0.00001% (0.1 ppm) to 1% by weight. The Ti ultra-fine particles or microfine powder are coated around with the surface-active agent in the mixed solution.

For the organic solvent, α-terpineol is used suitably. Aside from this, xylene, toluene, 2-methoxyethanol, and butanol may also be used.

When forming the seed layer, it is preferred that drying and firing be performed after the applying of the mixed solvent. The drying can be performed, for example, at around 200° C. to 400° C. for about 1 to 10 minutes. This can remove the solvent. The firing may be performed at temperatures for crystallizing the seed layer. In general, heating at around 450° C. to 750° C. for about 1 to 10 minutes will suffice.

According to the method described above, a film having the following properties can be stably formed.
La composition: Between 5 atomic percentage and 30 atomic percentage (inclusive);
Dielectric constant (at a frequency of 1 MHz): 1200 or higher;
Average grain size of PLZT: 800 nm or greater;
X-ray diffraction characteristic of PLZT: I(111)/I(110) is greater than or equal to 1 (where I(110) is the X-ray diffraction intensity on the (110) plane of PLZT and I(111) is the X-ray diffraction intensity on the (111) plane); and Peak half width of the X-way diffraction on the (111) plane of PLZT: 5 degrees or less.

Films having these properties are high in Kerr constant and show an excellent quadratic electro-optic effect. These films can thus be used suitably as the light modulating film 46 in the embodiments of the present invention.

### PRACTICAL EXAMPLES

Fabrication of PLZT Film

Pt films were formed on silicon substrates by sputtering, and films of PLZT were formed on the Pt films by the sol-gel method. The thickness of the Pt films is set to about 150 nm.

The metal atom ratios in the mixed solution for forming the film of PLZT is Pb:La:Zr:Ti=105:9: 65:35. The mixed solution was initially applied onto the Pt films by spin coating. The articles were heated at 150° C. for 30 minutes for pre-baking, and then at 450° C. for 60 minutes for pre-firing. This series of processes was repeated four times before final firing was performed in an oxygen atmosphere at 700° C. for one minute. After the firing, the PLZT films were cooled at the respective cooling rates shown in Table 1 (see below), whereby the samples were obtained.

Evaluations

The samples 1 to 3 in Table 1 were individually measured for the refractive index n, the dielectric constant ε, the Kerr constant R, and the grain size D. The X-ray diffraction spectra for the samples 1 and 3 were also measured.

The refractive indexes of the samples were calculated from their absorbances at 633-nm light. The dielectric constants of the samples were measured in an alternating electric field of 1 MHz. The average grain sizes of the crystals in the films were observed by a scanning electron microscope (SEM). The X-ray diffraction measurement was conducted under the condition of θ/2θ scanning and the wavelength of CuKα: 1.5418 Å.

TABLE 1

| | | | | | | X-RAY | X-RAY | |
|---|---|---|---|---|---|---|---|---|
| | | | RELATIVE | | | DIFFRACTION | DIFFRACTION | |
| SAM- | COOLING | | DIELECTRIC | KERR | GRAIN | INTENSITY | PEAK | |
| PLE | RATE | REFRACTIVE | CONSTANT ε | CONSTANT | SIZE | RATIO | HALF WIDTH | ESTIMATED |
| No. | (° C. min⁻¹) | INDEX n | (×10³) | (×10⁻¹⁶ m²V⁻²) | (nm) | I(111)/I(110) | (DEGREES) | STRUCTURE |
| 1 | 400 | 2.46 | 0.80 | 0.00 | 200 | 0.5 | 5.4 | PZT + La |
| 2 | 1200 | 2.76 | 1.16 | 0.01 | 200 | — | — | PZT + La |
| 3 | 1800 | 3.05 | 1.20 | 0.05 | 1000 | 30 | 4.1 | PLZT |

Measurement Results

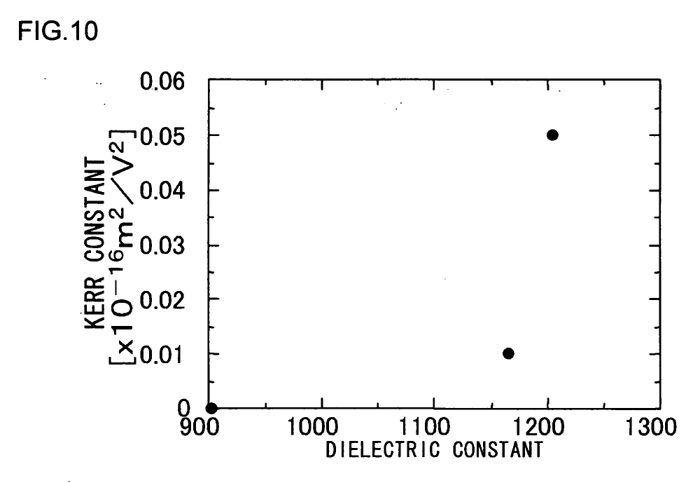

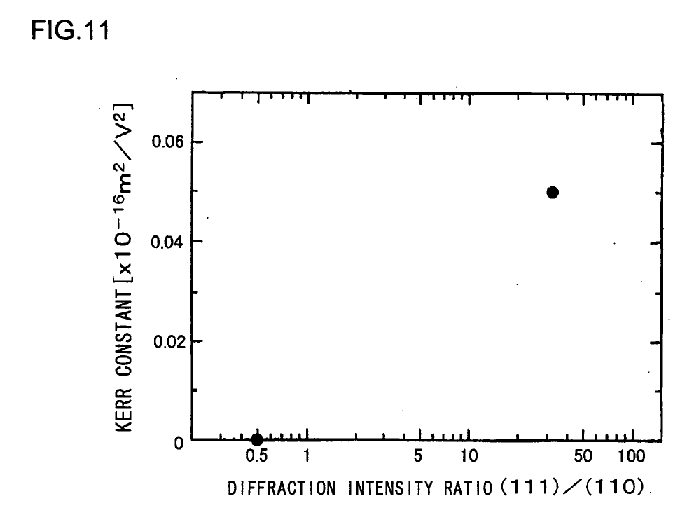

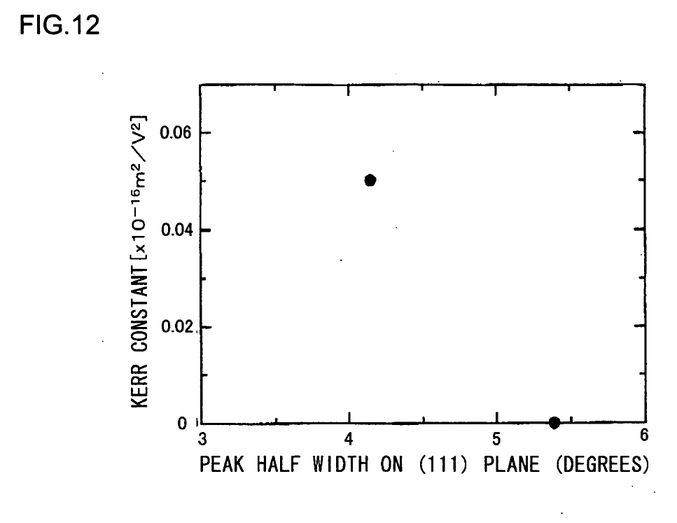

Table 1 shows the measurement results of the physical properties of the samples examined. FIG. 9 shows a relationship between the refractive index n and the Kerr constant R of the samples. FIG. 10 shows a relationship between the dielectric constant ε and Kerr constant R of the samples. FIG. 11 shows the ratios between the peak intensities on the (111) plane (2θ of the peak=approximately 38 degrees) and the (110) plane (2θ of the peak=approximately 31 degrees) in the X-ray diffraction spectra of the samples, which are plotted in relation to the Kerr constant R. FIG. 12 shows a relationship between the half width on the (111) plane (2θ of the peak=approximately 38 degrees) in the X-ray diffraction spectra and the Kerr constant.

From FIGS. 9 and 10 and Table 1, it is found that high Kerr constants are obtained from PLZT films having refractive indexes of 2.8 and above, or dielectric constants of 1200 and above. It is also found that an average grain size of approximately 1 μm provides a high Kerr constant.

These measurement results suggest that, in the sample 3, La in the crystals is taken into the grains because of the rapid cooling after the firing. Moreover, since the specific surface area increases with increasing average grain size, it may be speculated that this suppress the precipitation of La oxides (La₂O₃, for example).

On the other hand, it is found in the sample 1 that an additivity rule holds for the refractive indexes in the PZT phase and the La phase (La-oxide phase). This implies that the small cooling rate causes La oxides to precipitate and therefore both the PZT phase and the La phase are formed inside the film.

What was found from the results as shown in FIGS. 11 and 12 is as follows. Note here that the PLZT film seems to contain the mixture of cubic and tetragon.

From the results as shown in FIG. 11 it is found that the increase of the orientation of the entire film toward the (111) plane can improve the quadratic electro-optic effect. This may be attributed to the fact that the increased orientation toward the (111) plane can reduce deviations in orientation between the crystal grains. It is evident from FIG. 12 that reducing the peak half width on the (111) plane can also improve the quadratic electro-optic effect. The reason seems to be that the reduced peak half width improves the crystallinity of the film as a whole.

The present invention has been described based on the embodiments and practical embodiments. These embodiments and practical embodiments are merely exemplary, and various modifications to the combination of each component and process thereof are possible. It is understood by those skilled in the art that such modifications are also within the scope of the present invention.

The technology according to the present invention may be applied to optical elements such as liquid crystal or organic EL devices. However, such optical elements have a problem that when luminance data are switched, the previous luminance data remains, thus making high-speed switching very difficult to achieve. The use of a solid film of PLZT or the like, however, realizes a response faster than that of liquid crystal and thus allows the display of luminance data for the next frame without the problem of remaining luminance data of the previous frame. And in using PLZT, it is preferable that a material having no memory effect be used.

Nevertheless, optical elements, such as liquid crystal or organic EL devices, or PLZT having memory effect may also be used provided they are combined with existing technology for eliminating the problem of remaining luminance data.

While the preferred embodiments of the present invention have been described using specific terms, such description is for illustrative purposes only, and it is to be understood that changes and variations may be made without departing from the spirit or scope of the appended claims.

1. A light control apparatus including a plurality of two-dimensionally arranged pixels, each of the plurality of pixels comprising:
a first storage element which stores a luminance value of a present frame for the pixel;
a second storage element which stores a preliminary luminance value for the pixel; and
a switching element which changes the luminance value for the pixel by transferring the luminance value stored in the second storage element to the first storage element.

2. A light control apparatus according to claim 1, further comprising a control unit which simultaneously performs on/off of the switching elements each provided for the each of the plurality of pixels.

3. A light control apparatus according to claim 2, further comprising a control unit which writes the luminance values to said second storage element while the plurality of pixels are emitting light according to the luminance values held in the respective first storage elements.

4. A light control apparatus according to claim 1, wherein the plurality of pixels include a light modulating film having an electro-optical effect and a plurality of electrode pairs which are two-dimensionally arranged on the light modulating film.

5. A light control apparatus according to claim 2, wherein the plurality of pixels include a light modulating film having an electro-optical effect and a plurality of electrode pairs which are two-dimensionally arranged on the light modulating film.

6. A light control apparatus according to claim 3, wherein the plurality of pixels include a light modulating film having an electro-optical effect and a plurality of electrode pairs which are two-dimensionally arranged on the light modulating film.

7. A light control apparatus according to claim 4, wherein the light modulating film is made of PLZT that contains Pb, Zr, Ti and La as constituent elements.

8. A light control apparatus according to claim 5, wherein the light modulating film is made of PLZT that contains Pb, Zr, Ti and La as constituent elements.

9. A light control apparatus according to claim 6, wherein the light modulating film is made of PLZT that contains Pb, Zr, Ti and La as constituent elements.

10. A driving method for a light control apparatus which includes a plurality of two-dimensionally arranged pixels, the method characterized in that luminance values of a next frame are written sequentially to the plurality of pixels in a background while all the plurality of pixels are emitting light according to their respective luminance values of a present frame.

11. A driving method for a light control apparatus according to claim 10, wherein switching is made in a manner such that all the plurality of pixels emit light according to luminance values of the next frame after the luminance values of the next frame are written to all the plurality of pixels.
